(19) United States
(12) Patent Application Publication
(10) Pub. No.: US 2015/0361913 A1
(43) Pub. Date: Dec. 17, 2015

(54) METHOD AND APPARATUS FOR CONTROLLING AN INTERNAL COMBUSTION ENGINE WITH A LAMBDA SENSOR

(71) Applicant: GM GLOBAL TECHNOLOGY OPERATIONS LLC, Detroit, MI (US)

(72) Inventors: GONGSHIN QI, I, TROY, MI (US); WEI LI, TROY, MI (US)

(21) Appl. No.: 14/304,891

(22) Filed: Jun. 14, 2014

(51) Int. Cl. F02D 41/14; F01N 11/00; F01N 9/00

(52) U.S. Cl. CPC F02D 41/1456; F01N 9/007; F01N 11/007; F02D 41/1476

(57) ABSTRACT

A method for controlling an internal combustion engine includes commanding operation of the engine at a selected air/fuel ratio and adjusting a signal output from a lambda sensor corresponding to the selected air/fuel ratio. A controller executes control of the engine based upon the adjusted signal output from the lambda sensor corresponding to the selected air/fuel ratio.

### TECHNICAL FIELD

This disclosure is related to controlling internal combustion engines using wide-range air/fuel ratio sensors.

### BACKGROUND

The statements in this section merely provide background information related to the present disclosure. Accordingly, such statements are not intended to constitute an admission of prior art.

Compression-ignition internal combustion engines operate at lean air/fuel ratios to achieve desirable fuel efficiencies. Lean engine operation may produce oxides of nitrogen (NOx) when nitrogen and oxygen molecules present in engine intake air disassociate in the high temperatures of combustion. Rates of NOx production follow known relationships in the combustion process, for example, with higher rates of NOx production being associated with higher combustion temperatures and longer exposure of air molecules to the higher temperatures. NOx molecules may be reduced to elemental nitrogen and oxygen in aftertreatment devices. Efficiency and efficacy of known aftertreatment devices is dependent upon operating conditions including operating temperature, which is associated with exhaust gas flow temperatures and engine air/fuel ratio.

Aftertreatment systems include catalytic devices to carry out chemical reactions to purify and otherwise treat exhaust gas constituents. Lean NOx trap catalysts store NOx when an engine is operating at a lean air/fuel ratio, and subsequently purge and reduce the stored NOx to nitrogen and water during rich engine operating conditions. Diesel particulate filters (DPF) are able to trap particulate matter in the exhaust gas feedstream, which may then be periodically purged, e.g., during high temperature regeneration events.

A selective catalytic reaction device (SCR) includes catalytic material that promotes the reaction of NOx with a reductant such as ammonia (NH3) or urea to produce nitrogen and water. Reductants, e.g., urea, may be injected into an exhaust gas feedstream upstream of the SCR device. Reductants, e.g., NH3, may be generated in an exhaust gas feedstream upstream of the SCR device during specific engine operating conditions. An engine operating at a rich air/fuel ratio to purge and reduce stored NOx or operating to generate reductants can negatively affect engine fuel efficiency.

### SUMMARY

A method for controlling an internal combustion engine includes commanding operation of the engine at a selected air/fuel ratio and adjusting a signal output from a lambda sensor corresponding to the selected air/fuel ratio. A controller executes control of the engine based upon the adjusted signal output from the lambda sensor corresponding to the selected air/fuel ratio.

### BRIEF DESCRIPTION OF THE DRAWINGS

One or more embodiments will now be described, by way of example, with reference to the accompanying drawings, in which:

FIG. 1 illustrates a multi-cylinder internal combustion engine fluidly coupled to an exhaust aftertreatment system, in accordance with the disclosure;

FIG. 2 illustrates sensor output voltage (V) in relation to air/fuel ratio in the form of a lambda reading (λ) with data including a targeted lambda value and actual sensor readings from a wide-range air/fuel ratio (lambda) sensor during operation of an engine, in accordance with the disclosure;

FIG. 3 illustrates hydrogen (H₂) concentration (%) in relation to lambda sensor signal variation (%), with a line showing a linear sensitivity between the H₂ concentration (%) and the lambda sensor signal variation (%), in accordance with the disclosure;

FIG. 4 illustrates hydrocarbon concentration (ppm) in relation to lambda sensor signal variation (%) in accordance with the disclosure;

FIG. 5 illustrates ammonia concentration (ppm) in relation to lambda sensor signal variation (%) showing no sensitivity between the ammonia concentration (ppm) and the lambda sensor signal variation (%), in accordance with the disclosure; and

FIG. 6 illustrates an engine control routine for controlling an internal combustion engine in response to a command to operate at stoichiometry or at a rich air/fuel ratio, in accordance with the disclosure.

### DETAILED DESCRIPTION

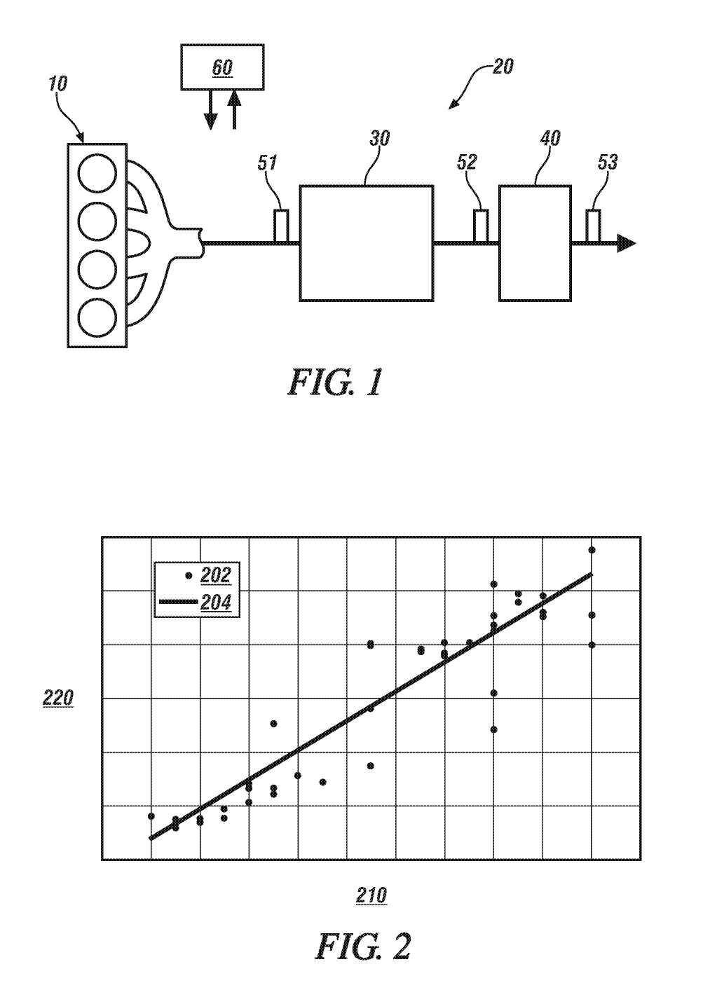

Referring now to the drawings, wherein the showings are for the purpose of illustrating certain exemplary embodiments only and not for the purpose of limiting the same, FIG. 1 illustrates a multi-cylinder internal combustion engine 10 fluidly coupled to an exhaust aftertreatment system 20 that purifies an exhaust gas feedstream from the engine 10. In one embodiment the internal combustion engine 10 is a compression-ignition engine that primarily operates at a lean air/fuel ratio. Alternatively, the internal combustion engine is a form of a spark-ignited direct-injection engine that operates at a lean air/fuel ratio under predetermined engine speed/load operating points. Operation of the engine 10 is monitored and controlled by an engine controller 60.

The exhaust system 20 is illustrative, and includes a first aftertreatment device 30 fluidly coupled to a downstream second aftertreatment device 40. When the internal combustion engine 10 is a compression-ignition engine, the first aftertreatment device 30 can be a lean NOx adsorber or trap (LNT) and the second aftertreatment device 40 can be a particulate filter in one embodiment. Alternatively, the first aftertreatment device 30 can be a lean NOx adsorber or trap (LNT) and the second aftertreatment device 40 can be a particulate filter coupled with a selective catalytic reactor (SCR) device. When the internal combustion engine 10 is a spark-ignition engine, the first aftertreatment device 30 can be an oxidation catalyst and the second aftertreatment device 40 can be a selective catalytic reactor (SCR) device in one embodiment. These exhaust configurations are illustrative. Other exhaust aftertreatment devices can be employed as substitutes for or in addition to the described aftertreatment devices. The catalyst element in the form of a lean NOx adsorber or trap (LNT) includes a substrate element coated with a washcoat that is capable of adsorbing and desorbing and reducing NOx molecules. The substrate element is coated with a washcoat including platinum-group metal catalysts, barium, and ceria in one embodiment.

The exhaust system 20 also includes one or a plurality of sensors that monitor the exhaust gas feedstream at various locations in the exhaust system 20. As shown, the sensors include a first sensor 51 configured to monitor the exhaust gas feedstream at an engine-out location, a second sensor 52 configured to monitor the exhaust gas feedstream downstream of the first aftertreatment device 30, and a third sensor 53 configured to monitor the exhaust gas feedstream downstream of the second aftertreatment device 40. Each of the sensors 51, 52, 53 signally connects to controller 60, and the signals are employed to control the engine 10 and monitor operation of the engine 10 and the various elements of the exhaust system 20 for purposes related to control under various operating conditions and related to fault detection and root-cause diagnosis.

One or more of the sensors 51, 52, 53 is a wide-range air/fuel ratio (lambda) sensor that generates a signal output that is monitored by a signal processor, with the signal processor generating an output signal that is responsive to air/fuel ratio of the sensed feedstream. The signal processor for a lambda sensor may be a stand-alone controller that signally connects to the controller 60, or may be incorporated into the controller 60. A change in air/fuel ratio generates a corresponding change in the output signal from the sensor that can be employed in engine control and monitoring routines. Construction and configuration of lambda sensors and accompanying signal processors is known and not described in further detail herein.

A lambda sensor generates a signal output under lean air/fuel ratio conditions (i.e., λ≧1.05) that has high correlation with measurement by a bench analyzer. Thus, a signal output from a lambda sensor measuring air/fuel ratio based upon measured oxygen (O₂) correlates with an air/fuel ratio calculated from measured exhaust gas constituents from a bench analyzer with minimal error. At stoichiometry and rich air/fuel ratios (λ≦1.0) there can be a significant difference between O₂ measured by a lambda sensor and O₂ measured by a bench analyzer. As shown with reference to FIG. 2, there is an indefinite relationship between the air/fuel ratio measured by the lambda sensor and O₂ concentration from exhaust gas composition when the engine is operating at air/fuel ratios rich of stoichiometry.

The general lambda sensor calculation can be represented in accordance with the following relationship:

λ=[O₂]*α+[CO]*β+[HC]*γ+[PM]*δ+[H₂]*ε [1]
wherein
   λ is lambda, which represents a ratio of actual air/fuel ratio and a stoichiometric air/fuel ratio for engine fuel,
   α, β, γ and ε are functions of squared molecular masses, and
   [O₂], [CO], [HC], [PM] and [H₂] are concentrations of oxygen, carbon monoxide, hydrocarbons, particulate matter and hydrogen, respectively.

During lean engine operation, contributions of CO, HC, PM and H₂ are almost negligible, but when λ<1.05, their contributions increase due to increased concentrations in the exhaust gas feedstream. H₂ and CO molecules are relatively small, with rapid diffusion through a lambda test cell, whereas HC and PM molecules are relatively large, with corresponding slower diffusion through the lambda test cell. When there are high concentrations of HC, CO and PM, available O₂ is used for oxidation. Thus, the lambda sensor may not be capable of sensing all the oxygen in the gas mixture. During LNT DeNOₓ regeneration, high amounts of NH₃, H₂ and HCs downstream of the catalyst have been measured. Thus, knowledge of cross-sensitivity between measured lambda value downstream of a LNT and the concentration of H₂, HCs and NH₃ is useful for adjusting signal measurement of a lambda sensor in rich conditions.

Control module, module, control, controller, control unit, processor and similar terms mean any one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or routines, combinational logic circuit(s), input/output circuit(s) and devices, appropriate signal conditioning and buffer circuitry, and other components to provide the described functionality. Software, firmware, programs, instructions, routines, code, algorithms and similar terms mean any instruction sets including calibrations and look-up tables. The controller has a set of control routines executed to provide the desired functions. Routines are executed, such as by a central processing unit, and are operable to monitor inputs from sensing devices and other networked control modules, and execute control and diagnostic routines to control operation of actuators. Routines may be executed at regular intervals, for example each 100 microseconds, 3.125, 6.25, 12.5, 25 and 100 milliseconds during ongoing engine and vehicle operation. Alternatively, routines may be executed in response to occurrence of an event.

FIG. 2 graphically shows sensor output voltage (V) on the horizontal axis 210 and air/fuel ratio in the form of a lambda reading (λ) on the vertical axis 220, with plotted data including a targeted lambda value 204 and actual sensor readings from a lambda sensor 202 during operation of an engine. As shown, there is wide scatter of the actual sensor readings from the lambda sensor 202 in comparison to the targeted lambda value, with a correlation that is R²=0.86. The different actual sensor readings from the lambda sensor associated with the same targeted lambda values occur under the different engine operating conditions and are caused at least in part by a cross-sensitivity with exhaust gas composition including potential sensitivities to variation in exhaust gas constituents of hydrocarbons (HC), ammonia (NH₃) and hydrogen (H₂).

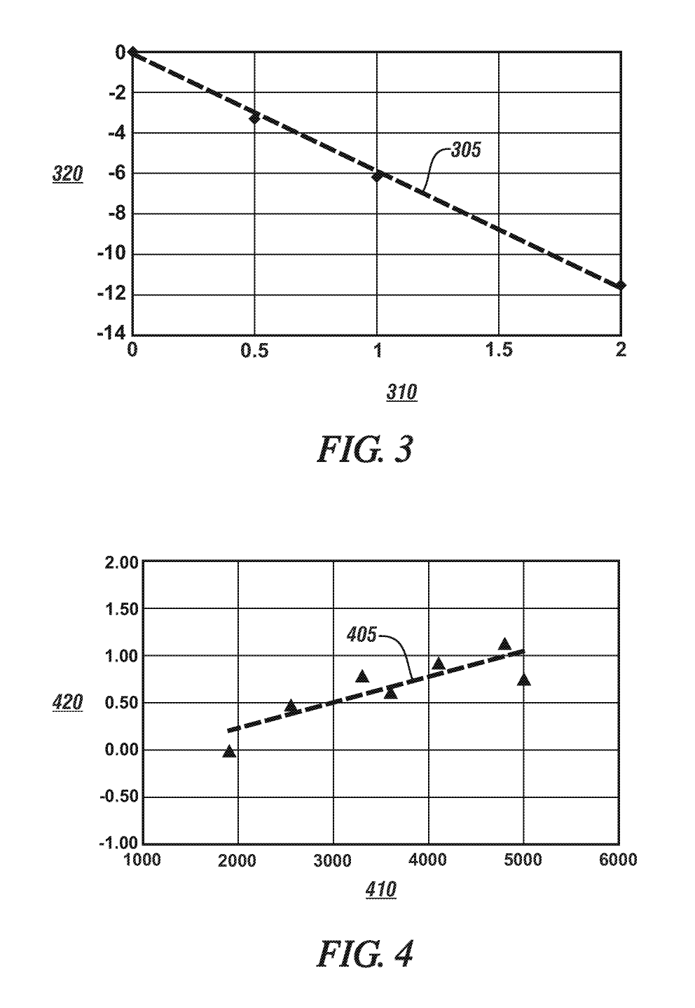

FIG. 3 graphically shows H₂ concentration (%) on the horizontal axis 310 and lambda sensor signal variation (%) on the vertical axis 320, with line 305 showing a linear sensitivity between the H₂ concentration (%) and the lambda sensor signal variation (%). This correlation is R²=0.99, and indicates that the lambda sensor signal shifts rich in the presence of H₂ with a deviation greater than 10% with H₂ concentration varying from 0% to 2%.

FIG. 4 graphically shows hydrocarbon concentration (ppm) on the horizontal axis 410 and lambda sensor signal variation (%) on the vertical axis 420, with line 405 showing some linear sensitivity between the hydrocarbon concentration (ppm) and the lambda sensor signal variation (%). These results indicate a minimal cross-sensitivity between the hydrocarbon concentration and the lambda sensor signal variation (%), with a deviation that approaches 1% for hydrocarbon concentrations varying from 0 to 5000 ppm.

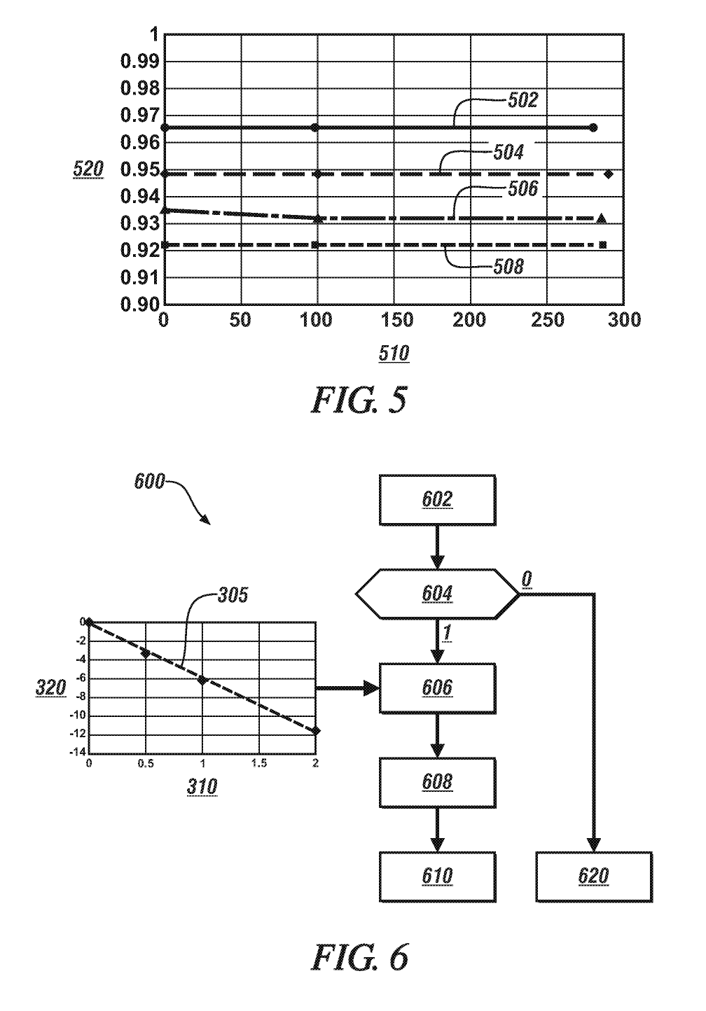

FIG. 5 graphically shows ammonia concentration (ppm) on the horizontal axis 510 and lambda sensor signal variation (%) on the vertical axis 520, with lines 502, 504, 506 and 508 showing no sensitivity between the ammonia concentration (ppm) and the lambda sensor signal variation (%). These results indicate no cross-sensitivity between the ammonia concentration (ppm) and the lambda sensor signal variation (%).

The results shown with reference to FIGS. 3, 4 and 5 indicate that a sensor correction factor can be determined based upon a cross-sensitivity with respect to hydrogen (H₂) that can be employed to adjust sensor readings from the lambda sensor under engine operating conditions that include rich air/fuel ratio engine operation. Such rich air/fuel ratio engine operation can be commanded during regeneration events for exhaust aftertreatment devices when rich operation is commanded to desorb NOx molecules and when rich operation is commanded to increase temperature in the exhaust gas feedstream. Cross-sensitivities caused by variations due to ammonia concentration and hydrocarbon concentration were shown to be negligible, and thus can ignored in one embodiment. It is appreciated that an embodiment that demonstrates a cross-sensitivity caused by variations due to other exhaust gas constituents, e.g., either or both ammonia concentration and hydrocarbon concentration can be developed to provide a sensor correction factor within the scope of this disclosure. Such embodiments can include, but are not limited to a system that employs an alternate embodiment for a lambda sensor that demonstrates cross-sensitivity caused by variations due to either or both ammonia concentration and hydrocarbon concentration.

FIG. 6 illustrates an exemplary engine control routine 600 for controlling an internal combustion engine in response to a command to operate at stoichiometry or at a rich air/fuel ratio. The engine control routine 600 is executed as one or more algorithms and control routines in a controller, and includes commanding operation of the engine at a selected air/fuel ratio, adjusting a signal output from a lambda sensor corresponding to the selected air/fuel ratio, and executing control of the engine responsive to the adjusted signal output from the lambda sensor corresponding to the selected air/fuel ratio, with such operation accounting for cross-sensitivity between the measured air/fuel ratio and exhaust gases produced as a byproduct of combustion under rich air/fuel ratio operating conditions. Table 1 is provided as a key to FIG. 6 wherein the numerically labeled blocks and the corresponding functions are set forth as follows.

TABLE 1

| BLOCK | BLOCK CONTENTS |
|---|---|
| 602 | Select air/fuel ratio (λ) for engine operation |
| 604 | Is selected air/fuel ratio rich, i.e., is λ < 1.0? |
| 606 | Determine shift in expected λ signal based upon selected |
| | air/fuel ratio |
| 608 | Adjust signal output from lambda sensor based upon shift in |
| | expected λ signal |
| 610 | Control engine operation to selected air/fuel ratio employing |
| | adjusted signal output from the lambda sensor |
| 620 | Control engine operation to selected air/fuel ratio employing |
| | non-adjusted signal output from the lambda sensor |

The engine control routine 600 executes by selecting an air/fuel ratio for engine operation, i.e., selecting λ (602) and determining if the selected air/fuel ratio is rich, i.e., is λ<1.0 (604). Engine operating conditions in which a rich air/fuel ratio may be selected include, by way of example, conditions associated with regenerating an exhaust aftertreatment device such as a lean NOx adsorber. By way of example only, a selected air/fuel ratio for engine operation may include commanding operation of the engine at a rich air/fuel ratio to effect regeneration of an exhaust aftertreatment device such as a lean NOx adsorber fluidly coupled to an exhaust outlet of the internal combustion engine, with the selected rich air/fuel ratio having a magnitude of λ=0.95 in one embodiment. When the selected air/fuel ratio is not rich, i.e., when λ≧1.0 (604)(0), engine operation is controlled to the selected air/fuel ratio employing a non-adjusted signal output from the lambda sensor. Engine control has been shown to be unaffected by cross-sensitivity between the measured air/fuel ratio and exhaust gases produced as a byproduct of combustion under lean air/fuel ratio operating conditions. Thus, no adjustment to the signal output from the lambda sensor is necessary (620).

When the selected air/fuel ratio is rich, i.e., when λ<1.0 (604)(1), engine operation is controlled to the selected air/fuel ratio employing an adjusted signal output from the lambda sensor. Adjusting the signal output from the lambda sensor corresponding to the selected air/fuel ratio under rich operation includes determining an expected exhaust gas hydrogen concentration at the selected air/fuel ratio, and determining a shift in an expected signal output from the lambda sensor at the selected air/fuel ratio based upon the expected exhaust gas hydrogen concentration (606). The shift in the expected signal output from the lambda sensor at the selected air/fuel ratio based upon the expected exhaust gas hydrogen concentration can be determined from data collected on a representative system that includes lambda sensor signal variation (%) in relation to hydrogen concentration (%). By way of illustration, FIG. 3 graphically shows one example of such representative data.

Alternatively, or in addition, adjusting the signal output from the lambda sensor corresponding to the selected air/fuel ratio under rich operation can include determining an expected concentration of a selected exhaust gas constituent, e.g., ammonia or a hydrocarbon, at the selected air/fuel ratio, and determining a shift in an expected signal output from the lambda sensor at the selected air/fuel ratio based upon the expected concentration of the selected exhaust gas constituent. Alternatively, or in addition, adjusting the signal output from the lambda sensor corresponding to the selected air/fuel ratio under rich operation can include determining expected concentrations of a plurality of selected exhaust gas constituents, e.g., hydrogen, ammonia and hydrocarbons, at the selected air/fuel ratio, and determining a shift in an expected signal output from the lambda sensor at the selected air/fuel ratio based upon the expected concentrations of the plurality of selected exhaust gas constituents.

The signal output from the lambda sensor is adjusted based upon the shift in the expected signal output from the lambda sensor (608). Engine operation is controlled to the selected air/fuel ratio employing the adjusted signal output from the lambda sensor to accommodate the cross-sensitivity between the measured air/fuel ratio and exhaust gases produced as a byproduct of combustion under rich air/fuel ratio operating conditions (610). This may include executing a closed-loop control of the engine employing the adjusted signal output from the lambda sensor as a feedback signal corresponding to the selected air/fuel ratio, thus causing the engine to adjust engine fueling in response to the adjusted signal output from the lambda sensor. Thus, engine operation can be controlled to the selected air/fuel ratio employing the adjusted signal output from the lambda sensor

By way of example, control, monitoring and diagnostics of an LNT are based on the information coming from lambda sensors located both upstream and downstream of the LNT. The lambda sensor output voltage is influenced by the reducing species concentration, such as carbon monoxide (CO), HCs and hydrogen whereas ammonia does not significantly influence the lambda sensor outputs. The adjusted signal output from the lambda sensor is used to ensure that the air/fuel ratio control through the lambda sensor in a rich environment works as intended to achieve a target lambda value within known accuracy. The adjusted signal output from the lambda sensor can be in the form of a correction factor that is determined based upon cross-sensitivity with respect to H₂ for lambda sensor reading adjustment during LNT regeneration events under rich air/fuel ratio operating conditions.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. Method for controlling an internal combustion engine, comprising:
commanding operation of the engine at a selected air/fuel ratio;
adjusting a signal output from a lambda sensor corresponding to the selected air/fuel ratio; and
executing, by a controller, control of the engine based upon the adjusted signal output from the lambda sensor corresponding to the selected air/fuel ratio.

2. The method of claim 1, wherein adjusting the signal output from the lambda sensor comprises:
determining an expected exhaust gas hydrogen concentration at the selected air/fuel ratio;
determining a shift in an expected signal output from the lambda sensor at the selected air/fuel ratio based upon the expected exhaust gas hydrogen concentration at the selected air/fuel ratio; and
adjusting the signal output from the lambda sensor based upon the shift in the expected signal output from the lambda sensor at the selected air/fuel ratio.

3. The method of claim 1, wherein the selected air/fuel ratio comprises a rich air/fuel ratio.

4. The method of claim 1, wherein executing control of the engine based upon the adjusted signal output from the lambda sensor corresponding to the selected air/fuel ratio comprises executing closed loop control of the engine responsive to the adjusted signal output from the lambda sensor corresponding to the selected air/fuel ratio.

5. Method for controlling an internal combustion engine, comprising:
commanding operation of the engine at a selected rich air/fuel ratio to effect regeneration of an exhaust aftertreatment device fluidly coupled to an exhaust outlet of the internal combustion engine;
adjusting a signal output from a lambda sensor corresponding to the selected rich air/fuel ratio; and
executing, by a controller, control of the engine based upon the adjusted signal output from the lambda sensor corresponding to the selected rich air/fuel ratio.

6. The method of claim 5, wherein adjusting the signal output the a lambda sensor comprises:
determining an expected exhaust gas hydrogen concentration at the selected rich air/fuel ratio;
determining a shift in an expected signal output from the lambda sensor at the selected rich air/fuel ratio based upon the expected exhaust gas hydrogen concentration at the selected rich air/fuel ratio; and
adjusting the signal output from the lambda sensor based upon the shift in the expected signal output from the lambda sensor at the selected rich air/fuel ratio.

7. Method for controlling an internal combustion engine, comprising:
commanding operation of the engine at a selected air/fuel ratio to effect regeneration of an exhaust aftertreatment device fluidly coupled to an exhaust outlet of the internal combustion engine;
adjusting a signal output from a lambda sensor corresponding to the selected air/fuel ratio; and
executing, by a controller, control of the engine based upon the adjusted signal output from the lambda sensor corresponding to the selected air/fuel ratio.

8. The method of claim 7, wherein adjusting the signal output from a lambda sensor comprises:
determining an expected concentration of an exhaust gas constituent at the selected air/fuel ratio;
determining a shift in an expected signal output from the lambda sensor at the selected air/fuel ratio based upon the expected concentration of the exhaust gas constituent at the selected air/fuel ratio; and
adjusting the signal output from the lambda sensor based upon the shift in the expected signal output from the lambda sensor at the selected air/fuel ratio.

9. The method of claim 7, wherein the selected air/fuel ratio comprises a rich air/fuel ratio.

10. The method of claim 7, wherein adjusting the signal output from the lambda sensor corresponding to the selected air/fuel ratio comprises:
determining expected concentrations of a plurality of exhaust gas constituents at the selected air/fuel ratio;
determining a shift in an expected signal output from the lambda sensor at the selected air/fuel ratio based upon the expected concentrations of the plurality of exhaust gas constituents at the selected air/fuel ratio; and
adjusting the signal output from the lambda sensor based upon the shift in the expected signal output from the lambda sensor at the selected air/fuel ratio.

11. The method of claim 10, wherein the plurality of exhaust gas constituents comprise hydrogen and hydrocarbons.

12. The method of claim 10, wherein the plurality of exhaust gas constituents comprise hydrogen, ammonia and hydrocarbons.
